(19) United States
(12) Patent Application Publication
(10) Pub. No.: US 2015/0094628 A1
(43) Pub. Date: Apr. 2, 2015

(54) COMPRESSION GARMENT VENTILATION

(71) Applicant: Covidien LP, Mansfield, MA (US)

(72) Inventors: Peter Crowley, Norfol, MA (US); Kristin L. Watson, North Attleboro, MA (US)

(73) Assignee: Covidien LP, Mansfield, MA (US)

(21) Appl. No.: 14/040,193

(22) Filed: Sep. 27, 2013

(51) Int. Cl. A61H 9/00; A61H 1/00

(52) U.S. Cl. CPC A61H 9/00; A61H 1/008
USPC 601/148

(57) ABSTRACT

A compression garment includes fluid-impermeable bladder layers defining an inflatable bladder. A ventilator is at least partially disposed on an inward side of the inflatable bladder. The ventilator at least partially defines at least one passage between the wearer's skin and the inward side of the bladder and in fluid communication with atmospheric air at a location outside of the compression garment when the compression garment is worn on the wearer's body part. The ventilator is flexible to collapse the at least one passage under the force of inflation of the bladder and to resiliently expand the at least one passage upon deflation of the bladder. The collapse of the at least one passage expels air from the at least one passage to the atmospheric air and the expansion of the at least one passage draws the atmospheric air into the at least one passage.

### TECHNICAL FIELD

The present disclosure generally relates to compression garments, and more particularly to compression garment ventilation.

### BACKGROUND

Intermittent pneumatic compression (IPC) systems are used for prophylactic treatment of deep vein thrombosis (DVT). An IPC can include a compression garment applied to a patient's body part.

Compression garments typically include fluid impervious portions that trap moisture, (such as perspiration, between the compression garment and the patient's body, causing discomfort. Discomfort can lead to a decrease in patient use of the compression garment.

### SUMMARY

The present disclosure is directed to compression garments and methods for reducing moisture build-up associated with compression garments during use and, additionally or alternatively, improving patient compliance in the use of such compression garments.

In one aspect, a compression garment includes fluid-impermeable bladder layers defining an inflatable bladder cyclically inflatable and deflatable to apply compression pressure to a part of a wearer's body. The inflatable bladder has an inward side and an outward side. The inward side is substantially opposite the outward side such that skin of the wearer is closer to the inward side than to the outward side when the compression garment is worn on the wearer's body part. A ventilator is at least partially disposed on the inward side of the inflatable bladder. The ventilator at least partially defines at least one passage between the wearer's skin and the inward side of the bladder and in fluid communication with atmospheric air at a location outside of the compression garment when the compression garment is worn on the wearer's body part. The ventilator is flexible to collapse the at least one passage under the force of inflation of the bladder and to resiliently expand the at least one passage upon deflation of the bladder. The collapse of the at least one passage expels air from the at least one passage to the atmospheric air and the expansion of the at least one passage draws the atmospheric air into the at least one passage.

In some embodiments, the ventilator has a proximal edge portion and a distal edge portion. The passage extends to at least one of the proximal and distal edge portions for fluid communication with the location outside of the compression garment when the passage expands upon deflation of the bladder.

In certain embodiment, the ventilator includes foam at least partially defining the at least one passage.

In some embodiments, the at least one passage is a plurality of spaced apart channels.

In certain embodiments, the ventilator includes spaced apart compression elements in mechanical communication with the inflatable bladder to transmit force from the inflatable bladder to the wearer's body when the compression garment is worn on the wearer's body.

In some embodiments, the at least one passage includes opposite side walls. The compression elements define the side walls of the at least one passage.

In certain embodiments, the compression elements include elongate tubes disposed along the inward side of the bladder.

In some embodiments, the elongate tubes each have a curved surface disposed toward the wearer's body part when the when the compression garment is worn on the wearer's body part.

In certain embodiments, the compression garment further includes a wicking layer disposed between the wearer's skin and the ventilator when the compression garment is worn on the wearer's body part.

In some embodiments, the wicking layer is secured at least around a perimeter of the inflatable bladder.

In certain embodiments, the wicking layer is unsecured to the at least one passage.

In some embodiments, the inflatable bladder defines a plurality of apertures extending through the bladder from the outward side to the inward side. The at least one passage is in fluid communication with one or more of the plurality of apertures.

In another aspect, a compression garment includes fluid-impermeable bladder layers defining an inflatable bladder cyclically inflatable and deflatable to apply cyclical compression pressure to a part of a wearer's body. The inflatable bladder has an inward side and an outward side. The inward side is substantially opposite the outward side such that skin of the wearer is closer to the inward side than to the outward side when the compression garment is worn on the wearer's body part. A ventilator is at least partially disposed on the inward side of the inflatable bladder. The ventilator at least partially defines at least one passage between the wearer's skin and the inward side of the bladder. The ventilator is inflatable to collapse the at least one passage and deflatable to expand the passage. The collapse of the passage expels air from the at least one passage and the expansion of the passage draws atmospheric air into the at least one passage.

In certain embodiments, the ventilator is deflated when the at least one bladder is inflated and inflated when the at least one bladder is deflated.

In some embodiments, the ventilator defines a plurality of holes establishing fluid communication between an inflatable portion of the ventilator and the wearer's skin when the compression garment is applied to the wearer's body.

In certain embodiments, the inflatable bladder and the ventilator are inflatable by a single pump in fluid communication with the inflatable bladder and the ventilator.

Embodiments can include one or more of the following advantages.

In some embodiments, the compression garment includes a ventilator that is flexible to collapse at least one passage under the force of inflation of a bladder and resiliently expand the at least one passage upon deflation of the bladder. In such embodiments, the collapse of the at least one passage expels air from the at least one passage to the atmospheric air and the expansion of the at least one passage draws the atmospheric air into the at least one passage. Thus, the change in shape of the passages act to create forced convective cooling in the area between the compression garment and the wearer's skin as the compression garment applies compressive therapy to the wearer's limb.

In certain embodiments, the ventilator is self-expanding to expand the at least one passage upon deflation of the bladder, drawing air into the passage to produce forced convective cooling of the area between the compression garment and the wearer's skin without the use of a second source of air and, additionally or alternatively, without the use of other moving components. Thus, for example, as compared to cooling solutions including additional moving parts, the change in shape of the passages to force convective cooling in the area between the compression garment and the wearer's skin is a robust and consistent cooling solution over prolonged periods of use.

In some embodiments, the passages of the ventilator provide convective cooling to the area between the compression garment and the wearer's skin while maintaining sufficient hemodynamic performance of the compression garment to apply effective compression therapy to the wearer's limb.

In certain embodiments, as compared to compression garments without passages, the passages can facilitate improved natural convective cooling in the area between the compression garment and the wearer's skin. Such improved natural convective cooling can reduce moisture build-up during periods in which the compression garment is worn before or between applications of compression therapy to the wearer's limb.

In some embodiments, the compression garment includes a ventilator including an inflatable member. The state of inflation of the inflatable member can be controlled (e.g., independently of the state of inflation of the bladders) to control the amount of cooling available through passages. Such control can facilitate, for example, balancing the amount of cooling with hemodynamic performance of the compression garment.

Other aspects, features, and advantages will be apparent from the description and drawings, and from the claims.

### BRIEF DESCRIPTION OF THE DRAWINGS

FIG. 1 is a view of an outward side of a compression garment, schematically illustrating a pump and tubing for cyclically inflating and deflating the garment.

FIG. 2 is a view of an inward side of the compression garment of FIG. 1.

FIG. 3 is a perspective of the compression garment of FIG. 1 secured to a leg of a wearer, with a portion of the garment broken away.

FIG. 4A is a cross-section taken along line 4-4 of the compression garment in FIG. 3, with a bladder of the compression garment inflated.

FIG. 4B is a cross-section taken along line 4-4 of the compression garment in FIG. 3, with the bladder deflated.

FIG. 5 is a view of an inward side of a compression garment, with a ventilator shown in phantom.

FIG. 6 is view of an outward side of a compression garment, with a ventilator shown in phantom.

FIG. 7 is a view of an inward side the compression garment of FIG. 6.

FIG. 8 is a view of an outward side of a compression garment, with a ventilator shown in phantom.

Corresponding reference characters indicate corresponding parts throughout the drawings.

### DETAILED DESCRIPTION

As used herein, the terms “proximal” and “distal” refer to relative locations of components, parts and the like of a compression garment when the garment is worn. For example, a “proximal” component is disposed most adjacent to the wearer's torso, a “distal” component is disposed most distant from the wearer's torso, and an “intermediate” component is disposed generally anywhere between the proximal and distal components. As used herein, “inward side” and “outward side” refer to the orientation of sides of a compression garment relative to a wearer when the compression garment is worn by the wearer. For example, an “inward side” of a compression garment is a side of the compression garment directed toward a wearer's skin when the compression garment is worn by the wearer, and an “outward side” of the compression garment is a side of the compression garment directed away from the wearer's skin when the compression garment is worn by the wearer.

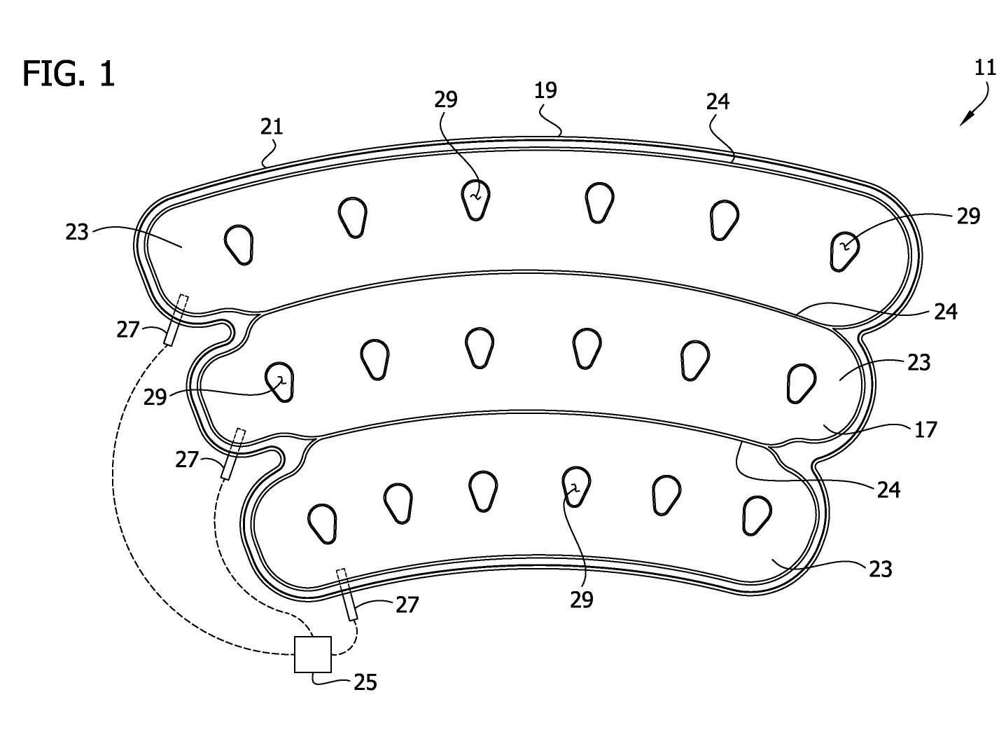

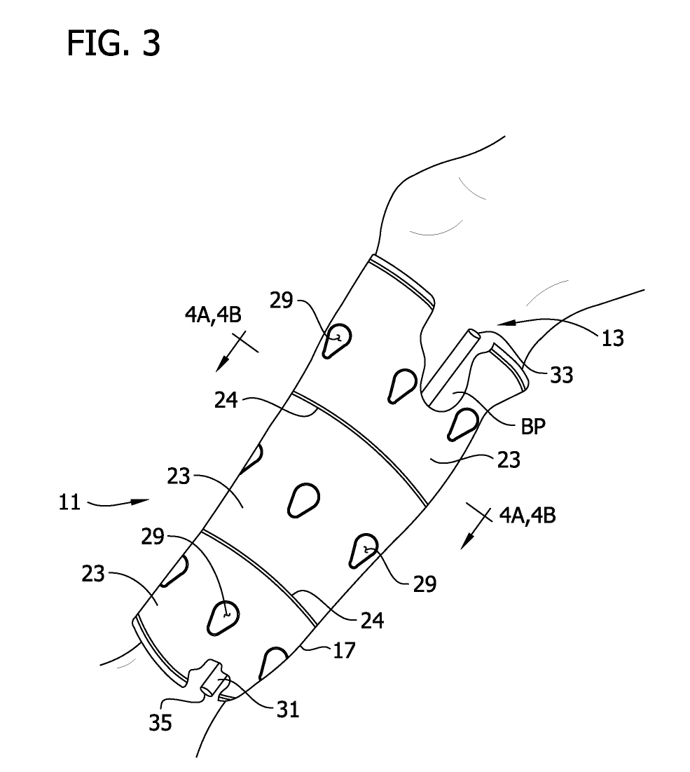

Referring to FIGS. 1-3, a compression garment 11 applies cyclical and sequential compression therapy to a limb of a wearer. As discussed in further detail below, the compression garment 11 includes a ventilator 13 for ventilating the wearer's limb when the compression garment 11 is worn. The compression garment 11 is shown as a knee-length sleeve positionable around the leg of the wearer. It will be understood, however, that the compression garment 11 may have different configurations such as, for example, a thigh-length sleeve. Compression garments for being disposed about other limbs of the wearer's body are also within the scope of this disclosure. These include, for example, garments that do not apply cyclical compression and/or garments that do not apply sequential compression.

The compression garment 11 includes an inner bladder layer 15 and an outer bladder layer 17. The inner bladder layer 15 and the outer bladder layer 17 are secured to one another, with the outer bladder layer 17 overlaid on the inner bladder layer 15. The bladder layers 15, 17 are secured together at a peripheral seam 19 extending generally about a periphery 21 of the sleeve 11. The bladder layers 15, 17 may be secured together, for example, by radiofrequency welding, adhesive, or other chemical and/or mechanical process. Bladders 23 are at least partially defined by bladder seams 24. The bladders 23 expand and contract under the influence of air pressure or other fluids delivered from a fluid source 25 (e.g., a pump) through respective conduits 27 in communication with the fluid source 25 and a respective volume defined by each of the bladders 23. The volume defined by each bladder 23 defines a compression region of each respective bladder 23. The compression region is generally bounded by the bladder seams 24, which provide a fluid tight boundary for the compression region. In some embodiments, the bladders 23 define openings 29 extending completely through the bladders 23 to facilitate, for example, removal of moisture away from the wearer's body through the openings 29.

The inner and outer bladder layers 15, 17 may each include a sheet of elastic material, generally referred to herein as bladder material. For example, the bladder layers 15, 17 can each include a pliable sheet of polyvinyl chloride (PVC). The bladder layers 15, 17 may be secured together at locations other than the bladder seams 24. Additionally or alternatively, the bladder layers 15, 17 may be formed from a single sheet of material folded over itself.

The ventilator 13 is at least partially disposed on an inward side of the inner bladder layer 15 for contacting the wearer's skin when the sleeve 11 is worn. The ventilator 13 includes a plurality of spaced apart compression elements 31 extending in a direction generally from a proximal edge portion 33 of the ventilator 13 to a distal edge portion 35 of the ventilator 13. The plurality of spaced apart compression elements 31 form a plurality of passages 39 also extending generally from the proximal edge portion 33 of the ventilator 13 to the distal edge portion 35 of the ventilator 13. It should be appreciated, however, that the compression members 31 and passages 39 can be arranged in other ways. For example, the compression members 31 and passages 39 can extend outward in a radial fashion from the openings 29.

Referring now to FIGS. 1-4B, when the compression garment 11 is wrapped around a body part BP of the wearer, the passages 39 are defined by the side walls 36 of the compression elements 31, the inward side of the inner bladder layer 15, and the wearer's skin S. For example, each passage 39 can be a channel substantially open toward the wearer. The passages 39 provide ventilation for the wearer's skin S through fluid communication between the passages 39 and atmospheric air at a location through the openings 29 in the bladders 23 and/or the proximal and distal edge portions 33, 35 of the ventilator 13, as will be explained in greater detail below.

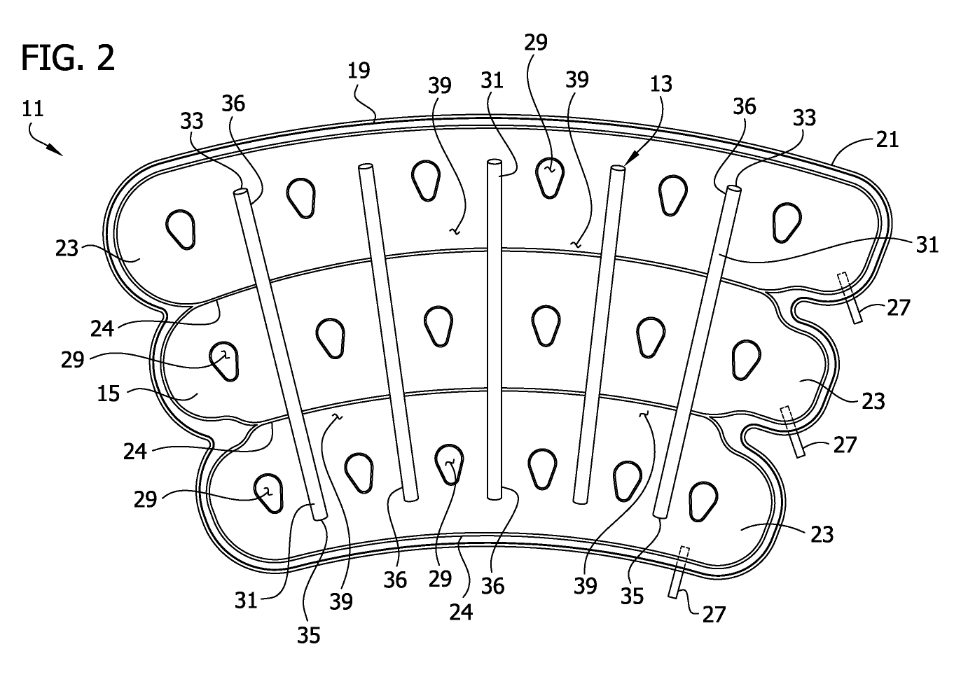

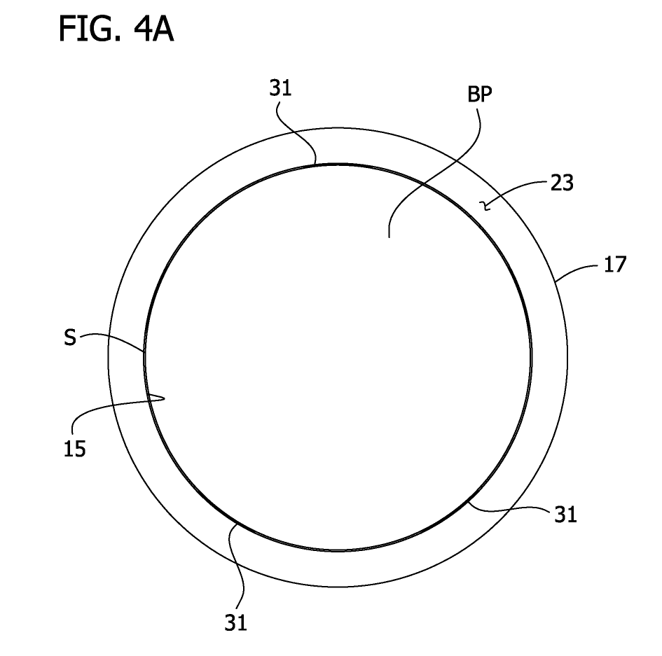

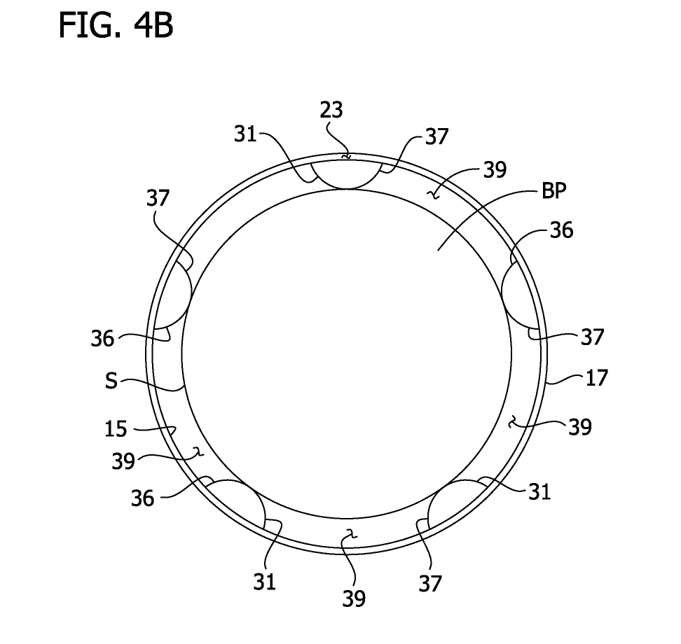

The compression elements 31 are flexible to collapse under an external compressive force (e.g., a force of inflation of the bladders 23) to collapse the passages 39 (FIG. 4A). The compressive elements 31 are also flexible to resiliently expand the passages 39 when the external compressive force is removed (e.g., when the bladders 23 are deflated) (FIGS. 2 and 4B).

Each compression elements 31 can have a dome shaped cross-section forming a curved outer surface 37 disposed toward the wearer's limb when the compression garment 11 is worn. Additionally or alternatively, each compression elements 31 can include an elongate foam member with an open cell volume that collapses under the application of compression pressure and expands upon removal of compression pressure. Alternatively or in addition, each compression element 31 may include a flexible tube that collapses under the application of compression pressure and expands upon removal of compression pressure.

In use, the compression garment 11 is wrapped around the wear's limb, with the bladders 23 typically in a deflated state in which each bladder 23 is substantially devoid of an inflation fluid. With the bladders 23 in the deflated state, the compression elements 31 have an expanded configuration such that the passages 39 are defined between the bladder layer 15 and the wearer's skin S (FIG. 4B). In the expanded configuration, the passages 39 are in fluid communication with atmospheric air at the proximal edge portion 33 and distal edge portion 35 of the ventilator 13 and/or through the openings 29 in the bladders 23. Air can circulate through the passages 39 when the bladders 23 are deflated and the compression elements 31 are expanded. For example, if the compression garment 11 is worn by the wearer, but compression therapy is not being applied to the wearer's body part BP (e.g., prior to treatment or between treatments) air can move through the passages through natural convection. This air circulation can help to keep the wearer's limb cool and reduce moisture build-up between the compression garment 11 and the wearer's body part BP.

Inflation of the bladders 23 causes the bladders 23 to swell applying a compression force toward the wearer's body part BP. The compression force applied by the bladders 23 compresses the compression elements 31 between the bladders 23 and the wearer's body part BP, collapsing the compression elements 31 (FIG. 4A). Spacing between the body part BP and the inner layer 15 is exaggerated in FIG. 4A to illustrate the collapsed compression elements 31. As the compression elements 31 are collapsed the passages 39 are also collapsed expelling air from the passages 39 to the atmosphere. With the compression elements 31 collapsed, the inner bladder layer 15 is substantially flat against the wearer's limb BP so that the inflated bladders 23 can uniformly cover the wearer's body part BP except for the locations of the openings 29. The substantially uniform coverage of the bladders 23 can facilitate application of effective compression therapy to the wearer's body part BP. For example, the substantially uniform coverage of the inflated bladders 23 on the wearer's body part BP can exhibit hemodynamic performance similar to hemodynamic performance a compression garment without the compression elements 31.

After an inflation phase where the bladders 23 are inflated, the compression garment 11 can undergo a deflation phase where the bladders 23 are deflated. During the deflation phase, fluid in the bladders 23 is vented out of the bladders 23, removing the compression force exerted by the bladders 23 on the wearer's body part BP during the inflation phase. The removal of the compression force of the bladders 23 results in expansion of the compression elements 31 (FIG. 4B).

The passages 39 open as the bladders 23 deflate and the compression elements 31 expand. Atmospheric air is drawn into the passages 39 under a negative pressure caused by the opening the passages 39. For example, the negative pressure can draw atmospheric air into the passages 39 at the proximal and distal edge portions 33, 35 of the ventilator 13 and/or through the openings 29 in the bladders 23. Air flows out of the passages 39 when the compression elements 31 are compressed. For example, the positive pressure of the expansion of the bladders 23 to compress the compression elements 31 can be sufficient to compress the passages 39 to expel air from the passages 39. Thus, it should be appreciated that the repeated opening and closing of the passages 39 (e.g., resulting from the cyclical inflation and deflation of the bladders 23 during the course of compression therapy) can draw air into the passages 39 and expel air from the passages 39 to produce forced convective cooling near the wearer's skin S.

While certain embodiments have been described, other embodiments are possible.

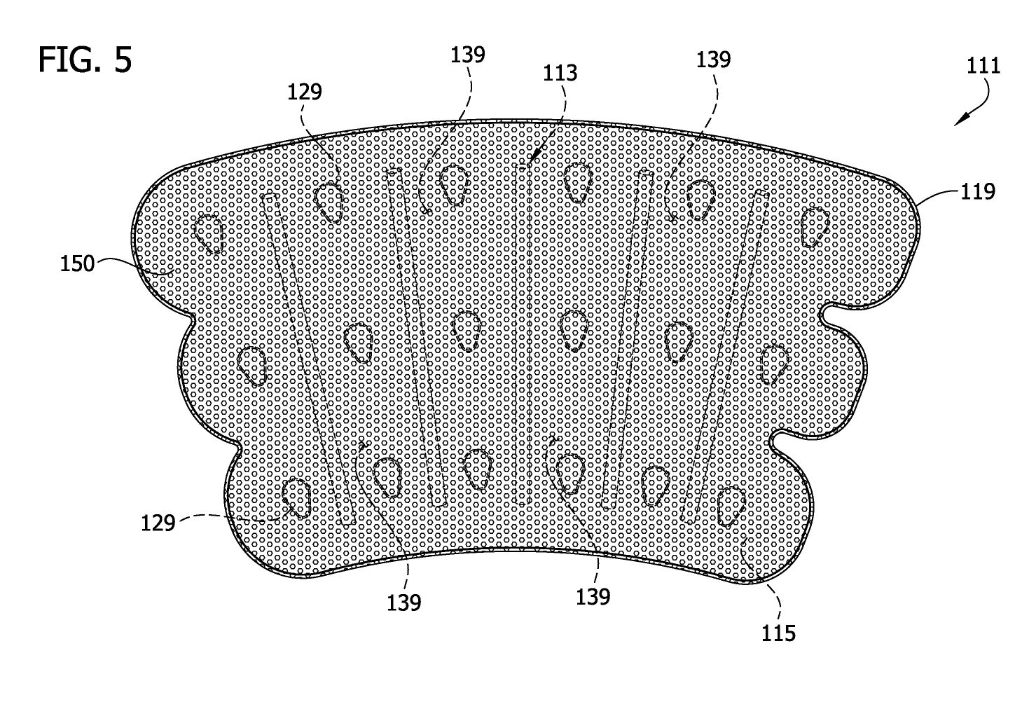

For example, while compression garments have been described as including ventilators including components in contact with a wearer's limb, other configurations are additionally or alternatively possible. For example, referring to FIG. 5, a compression garment 111 includes an inner layer 150. The inner layer 150 is secured at least to an inner bladder layer 115 at a peripheral seam 119. The inner layer 150 is disposed over a ventilator 113 and, in some embodiments, is not directly secured to the ventilator 113. The inner layer 150 includes a mesh material through which air can easily flow into and out of passages 139 defined by the ventilator 113.

The inner layer 150 is disposed for contacting the wearer's skin when the compression garment 111 is worn. The inner layer 150 can be constructed, for example, of a material capable of wicking moisture away from the wearer's skin. For example, the inner layer 150, through capillary action along a yarn filament surface of the layer, can draw in moisture trapped near the skin of the wearer, and carry the moisture away from the surface of the skin, transporting the moisture from locations where the moisture is abundant to areas where moisture is less abundant for evaporation to the ambient environment. For example, moisture may be transported toward areas of the inner layer 150 underneath openings 129.

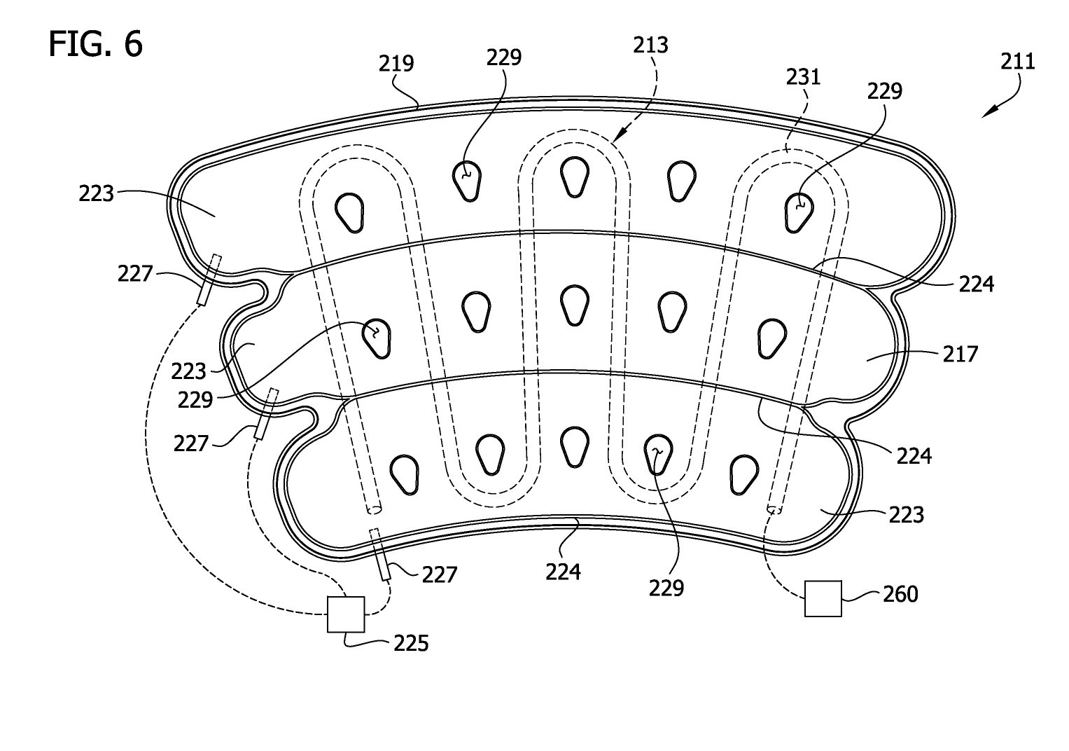

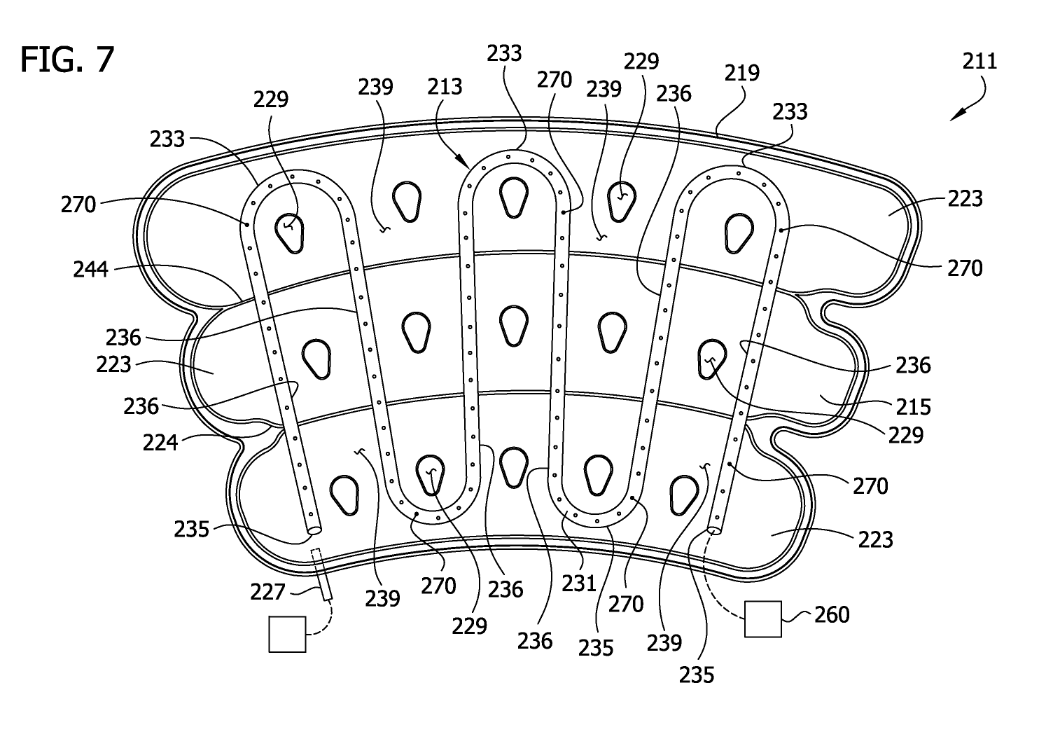

As another example, while the compression garments have been described as having ventilators with compression elements that self-expand to draw air into passages, other configurations are additionally or alternatively possible. For example, referring to FIGS. 6 and 7, a compression garment 211 includes a ventilator 213 including an inflatable member 231, as described in further detail below. The compression sleeve 211 includes an inner bladder layer 215 and an outer bladder layer 217. The inner bladder layer 215 and the outer bladder layer 217 are secured together at a peripheral seam 219 generally about a periphery 221 of the sleeve 211. The inner bladder layer 215 and the outer bladder layer 217 are secured together at bladder seams 224 to define bladders 223. The bladders 223 expand and contract under the influence of air pressure or other fluids delivered from a pump or fluid source 225 through respective conduits 227 in communication with the fluid source 225 and a volume defined by the bladders 223. In some embodiments, the bladders 223 define openings 229 extending completely through the bladders 223.

A ventilator 213 is positioned to ventilate the wearer's skin during use of the compression garment 211. The ventilator 213 includes an inflatable member 231 disposed along the inner bladder layer 215, toward and inward side of the compression garment 211. The inflatable member 231 is fluidly connectable to a fluid source 260 to inflate the inflatable member 231. The inflatable member 231 defines a plurality of perforations 270 through which air can be expelled when the inflatable member 231 is inflated. The combined open area of the perforations 270 is relatively small such that the inflatable member 231 can expand to an extent while air exits through the perforations 270 to cool the wearer's skin. The inflatable member 231 can have a dome-shaped cross-section when inflated to form a curved outer surface disposed toward the wearer's limb when the compression garment 211 is worn. The inflatable member 231 can be deflated to remove fluid from the inflatable member. It should be appreciated that the inflatable member 231 may be a single inflatable member or a plurality of separate and distinct inflatable members.

Side walls 236 of adjacent sections of the inflatable member 231 and the inner bladder layer 215 define a plurality of passages 239. The passages 239 provide fluid communication from a compression region defined by the bladders 223 to locations outside of, or out from underneath, the compression garment 211. For example, the plurality of passages 239 can provide fluid communication from the compression region to one or more of the following: the openings 229 in the bladders 223, and proximal and distal edge portions 233, 235 of the ventilator 213, as described in greater detail below.

The compression garment 211 is wrapped around the wearer's limb and pressurized fluid is delivered through conduits 227 into the bladders 223 to inflate the bladders. Prior to inflation, the bladders 223 are typically in a deflated state. With the bladders 223 in the deflated state, the inflatable member 231 of the ventilator 213 can be inflated such that expansion of the inflatable member 231 defines the passages 239. It should be appreciated that, when the sleeve 211 is wrapped around the wearer's limb, the passages 239 are defined by the side walls 236 of the inflatable member 231, the inward side of the inner bladder layer 215, and the wearer's skin. The passages 239 provide ventilation for the wearer's skin through fluid communication between the passages 239 and atmospheric air.

During inflation of the bladders 223, the inflatable member 231 can be deflated. As the inflatable member 231 deflates the passages 239 collapse and fluid in the passages is expelled from the passages such that the inflatable member 231 lies substantially flat against the inner bladder layer 215. With the inflatable member 231 deflated, the inflated bladders 223 can uniformly cover the wearer's limb, except for the locations of the openings 229. The substantially uniform coverage of the inflated bladders 223 on the wearer's limb can facilitate application of effective compression therapy to the wearer's limb.

During deflation of the bladders 223, the inflatable member 231 can be inflated to open the passages 239. Atmospheric air is drawn into the passages 239 under a negative pressure caused by expansion of the volume of the passages 239. The atmospheric air can be drawn into the passages 239 at the proximal edge portion 233 and/or the distal edge portion 235 of the ventilator 213 and/or through the openings 229 in the bladders 223. This circulation of atmospheric air ventilates the wearer's skin underneath the bladders 223, reducing discomfort that can be associated with the buildup of perspiration underneath the bladders 223.

Although a single inflatable member 231 is shown, other configurations are additionally or alternatively possible. For example, each bladder 223 may have a dedicated inflatable member that is inflated and deflated in response to the deflation and inflation of a respective bladder.

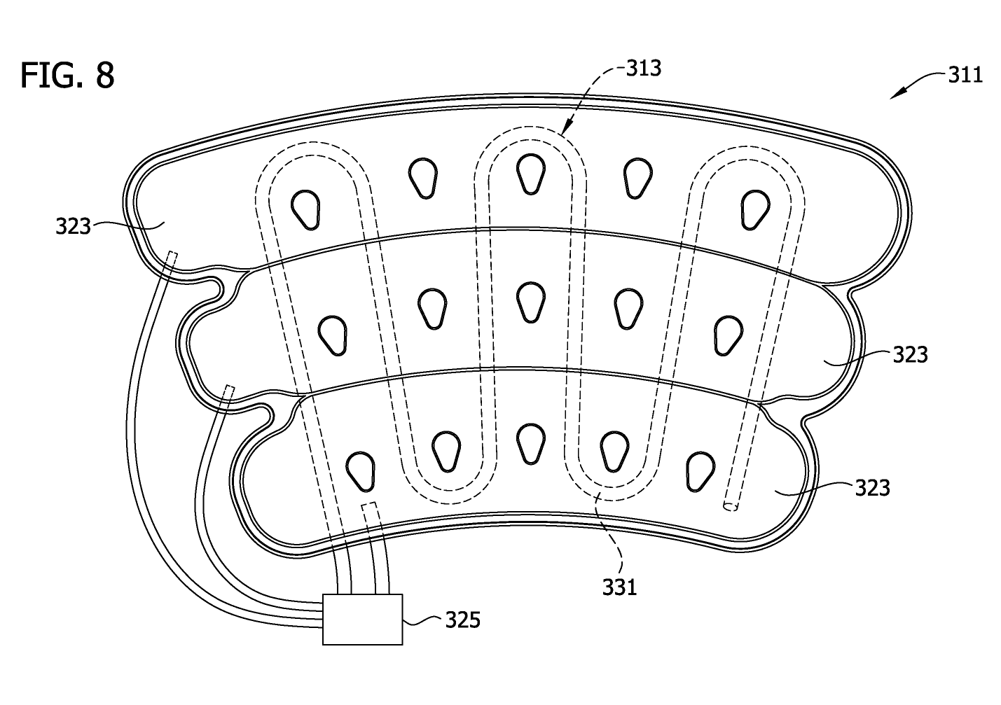

As yet another example, while compression garments have been described as including inflatable members inflatable by dedicated fluid sources, other configurations are additionally or alternatively possible. For example, referring to FIG. 8, a compression garment 311 includes bladders 323 and a ventilator 313 including an inflatable member 331. The bladders 323 and inflatable member 331 may be inflated and deflated by a single fluid source 325 (e.g., a pump) in fluid communication with both the bladders 323 and the inflatable member 331. Operation of the compression garment 311 is otherwise similar to that of compression garment 211.

A number of embodiments have been described. Nevertheless, it will be understood that various modifications may be made without departing from the spirit and scope of the disclosure. Accordingly, other embodiments are within the scope of the following claims.

What is claimed is:

1. A compression garment comprising:
fluid-impermeable bladder layers defining an inflatable bladder cyclically inflatable and deflatable to apply compression pressure to a part of a wearer's body, the inflatable bladder having an inward side and an outward side, the inward side substantially opposite the outward side such that skin of the wearer is closer to the inward side than to the outward side when the compression garment is worn on the wearer's body part; and
a ventilator at least partially disposed on the inward side of the inflatable bladder, the ventilator at least partially defining at least one passage between the wearer's skin and the inward side of the bladder and in fluid communication with atmospheric air at a location outside of the compression garment when the compression garment is worn on the wearer's body part, the ventilator flexible to collapse the at least one passage under the force of inflation of the bladder and to resiliently expand the at least one passage upon deflation of the bladder, the collapse of the at least one passage expelling air from the at least one passage to the atmospheric air and the expansion of the at least one passage drawing the atmospheric air into the at least one passage.

2. The compression garment of claim 1, wherein the inflatable bladder defines at least one aperture extending through the bladder from the outward side to the inward side, the at least one passage in fluid communication with said at least one aperture.

3. The compression garment of claim 1, wherein the ventilator comprises foam at least partially defining the at least one passage.

4. The compression garment of claim 1, wherein the at least one passage is a plurality of spaced apart channels.

5. The compression garment of claim 1, wherein the ventilator comprises spaced apart compression elements in mechanical communication with the inflatable bladder to transmit force from the inflatable bladder to the wearer's body when the compression garment is worn on the wearer's body.

6. The compression garment of claim 5, wherein the at least one passage includes opposite side walls, and the compression elements define the side walls of the at least one passage.

7. The compression garment of claim 6, wherein the compression elements comprise elongate tubes disposed along the inward side of the bladder.

8. The compression garment of claim 7, wherein the elongate tubes each have a curved surface disposed toward the wearer's body part when the compression garment is worn on the wearer's body part.

9. The compression garment of claim 1, further comprising a wicking layer disposed between the wearer's skin and the ventilator when the compression garment is worn on the wearer's body part.

10. The compression garment of claim 9, wherein the wicking layer is secured at least around a perimeter of the inflatable bladder.

11. The compression garment of claim 9, wherein the wicking layer is unsecured to the at least one passage.

12. The compression garment of claim 1, wherein the ventilator has a proximal edge portion and a distal edge portion, the passage extending to at least one of the proximal and distal edge portions for fluid communication with the location outside of the compression garment when the passage expands upon deflation of the bladder.

13. A compression garment comprising:
fluid-impermeable bladder layers defining an inflatable bladder cyclically inflatable and deflatable to apply cyclical compression pressure to a part of a wearer's body, the inflatable bladder having an inward side and an outward side, the inward side substantially opposite the outward side such that skin of the wearer is closer to the inward side than to the outward side when the compression garment is worn on the wearer's body part; and
a ventilator at least partially disposed on the inward side of the inflatable bladder, the ventilator at least partially defining at least one passage between the wearer's skin and the inward side of the bladder, the ventilator inflatable to expand the at least one passage and deflatable to collapse the passage, the collapse of the passage expelling air from the at least one passage and the expansion of the passage drawing atmospheric air into the at least one passage.

14. The compression garment of claim 13, wherein the ventilator is deflated when the at least one bladder is inflated and inflated when the at least one bladder is deflated.

15. The compression garment of claim 13, wherein the ventilator defines a plurality of holes establishing fluid communication between an inflatable portion of the ventilator and the wearer's skin when the compression garment is applied to the wearer's body.

16. The compression garment of claim 13, wherein the inflatable bladder and the ventilator are inflatable by a single pump in fluid communication with the inflatable bladder and the ventilator.
